(19) United States
(12) Patent Application Publication
(10) Pub. No.: US 2013/0169598 A1
(43) Pub. Date: Jul. 4, 2013

(54) DISPLAY SYSTEM AND DISPLAY DEVICE

(71) Applicants: Yutaka Kitamori, Moriguchi City (JP); Hisaharu Nakashima, Moriguchi City (JP)

(72) Inventors: Yutaka Kitamori, Moriguchi City (JP); Hisaharu Nakashima, Moriguchi City (JP)

(73) Assignee: SANYO ELECTRIC CO., LTD., Moriguchi City, Osaka (JP)

(21) Appl. No.: 13/822,183

(22) PCT Filed: Sep. 14, 2011
(86) PCT No.: PCT/JP2011/070994

§ 371 Date: Mar. 11, 2013

(30) Foreign Application Priority Data
Nov. 30, 2010 (JP) 2010-266524
Feb. 25, 2011 (JP) 2011-040200

(51) Int. Cl. G06F 3/042

(52) U.S. Cl. CPC G06F 3/042
USPC 345/176

(57) ABSTRACT

A display system according to the present invention is provided with a display unit, a display control unit, a touch panel, and a detection unit for detecting contact with respect to the touch panel. In the case of a first operation mode, the display control unit performs predetermined display when there has been contact at the location of a predetermined image on the touch panel. In the case of a second operation mode, the display control unit implements a display system for performing predetermined display when there has been contact on the touch panel, regardless of whether or not the predetermined image is present and regardless of the location of said contact.

### TECHNICAL FIELD

The present invention relates to display systems and display devices.

### BACKGROUND ART

Today, digital signage, that is, advertising content, messages, and the like shown on displays and the like installed outdoors or in public facilities, is quite common. Such displays for advertisement are used, for example, at bus stops (Patent Document 1). Many of such displays are provided with a touch panel on the display surface.

### LIST OF CITATIONS

### Patent Literature

Patent Document 1: Japanese Patent Application Published No. 2009-294284 (FIG. 3)

### SUMMARY OF THE INVENTION

### Technical Problem

Some displays for digital signage have two operating modes, namely a normal mode and a demonstration mode. Conventionally, in both the normal and demonstration modes, when the user touches the touch panel at the position where a button or icon is shown, a predetermined display is shown. Such an operation may be normal in the normal mode, but the same operation can be annoying to the user in the demonstration mode.

### Solution to the Problem

According to one aspect of the invention, a display system is provided with:

a display portion;

a display control portion;

a touch panel; and

a detection portion for detecting a touch on the touch panel, wherein

in a first operation mode, the display control portion shows a predetermined display when the touch on the touch panel occurs at the position of a predetermined figure, and

in a second operation mode, the display control portion shows the predetermined display whenever the touch occurs, irrespective of the presence or absence of the predetermined figure and irrespective of the position of the touch.

According to another aspect of the invention, a display device is provided with:

a display portion;

a display control portion;

a light-transmitting touch panel provided on the front face side of the display portion; and

an electrically conductive member provided outside the image display area where the display portion displays an image, wherein

the display control portion controls the display portion to show a predetermined display when a touch occurs on the touch panel or on the electrically conductive member.

According to another aspect of the invention, a display device is provided with:

a display portion;

a display control portion;

a light-transmitting touch panel provided on the front face side of the display portion; and

an electrically conductive member provided such that part thereof is located opposite the region of the touch panel outside the image display area of the display portion and overlapped by the detection-enabled area of the touch panel, wherein

the display control portion controls the display portion to show a predetermined display when a touch occurs on the touch panel or on the electrically conductive member.

### BRIEF DESCRIPTION OF DRAWINGS

FIG. 1 is an exterior view of an outdoor display system 100 according to a first embodiment of the invention;

FIG. 2 is a block diagram of the outdoor display system 100 according to the first embodiment of the invention;

FIG. 3 is a flow chart showing an example of screen operation control according to the first embodiment of the invention;

FIG. 4 is a diagram showing an example of screen display switching according to the invention;

FIG. 5 is a front view of a display device 200 according to a second embodiment of the invention;

FIG. 6 is a side view of the display device 200 according to the second embodiment of the invention;

FIG. 7 is a bottom view of the display device 200 according to the second embodiment of the invention;

FIG. 8 is a front view of a touch panel;

FIG. 9 is a partial sectional view, showing part of the section along line A-A in FIG. 5;

FIG. 10 is a diagram showing only cabinets out of what is shown in FIG. 9;

FIG. 11 is a partial sectional view, showing part of the section along line B-B in FIG. 5;

FIG. 12 is a block configuration diagram of a display system 300 according to the second embodiment of the invention;

FIG. 13 is a flow chart showing an example of screen operation control according to the second embodiment of the invention;

FIG. 14 is a front view of a kiosk terminal 400 according to one embodiment of the invention;

FIG. 15 is a diagram showing a modified example 200″ of a display device according to the invention;

FIG. 16 is a partial sectional view showing a modified example of a display device according to the invention; and

FIG. 17 is a partial sectional view showing a modified example of a display device according to the invention.

### DESCRIPTION OF EMBODIMENTS

Embodiments of the present invention will be described below with reference to the accompanying drawings.

### Embodiment 1

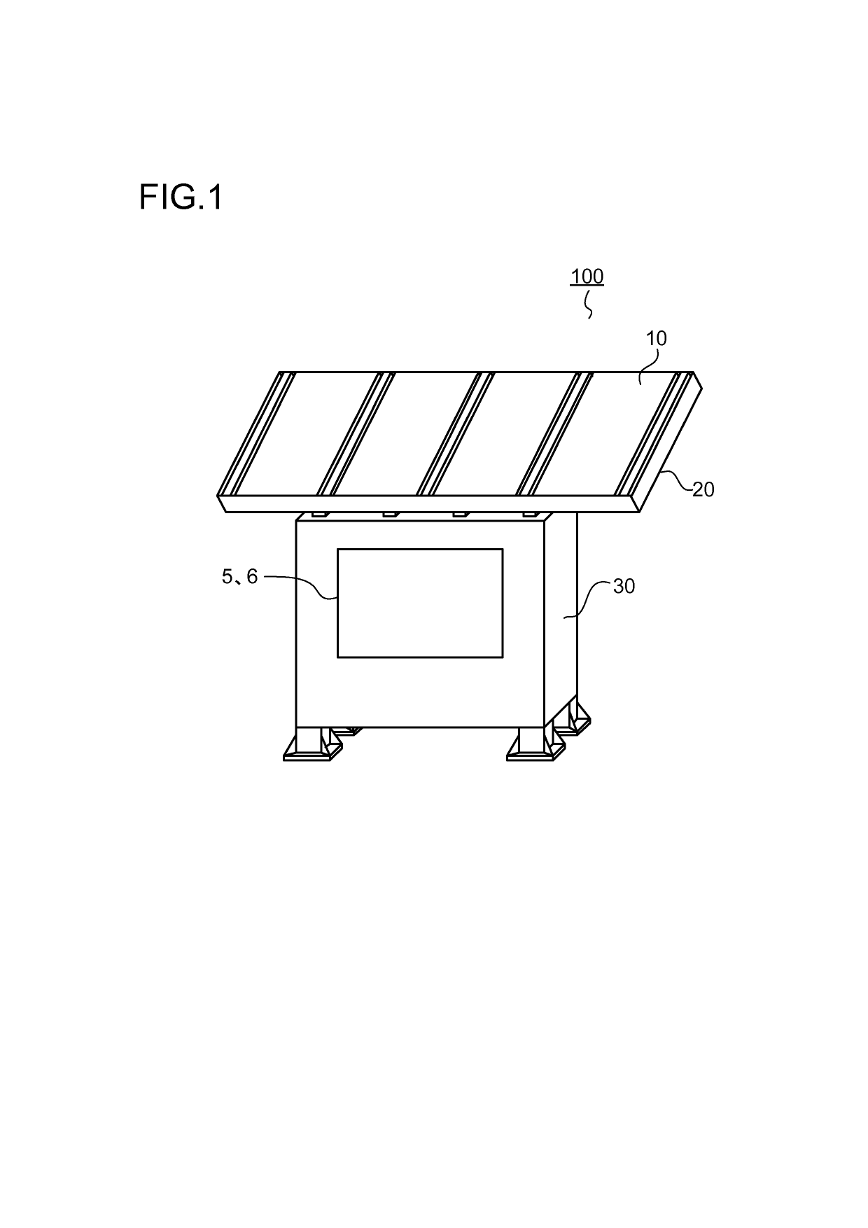

An exterior view of an outdoor display system according to a first embodiment of the invention is shown in FIG. 1.

The outdoor display system 100 includes a solar cell 10, a mounting base 20, and a display device 30. The outdoor display system 100 further includes, behind the display device 30, a controller 40 and a rechargeable battery 50.

The solar cell 10 is mounted on the mounting base 20 provided over the display device 30, and photoelectrically converts the received solar light to generate electric power. The electric power obtained by the solar cell 10 is, via the controller 40, stored in the rechargeable battery 50. The rechargeable battery 50 is, for example, a lithium ion battery.

The display device 30 is provided with a display panel 5. The display device 30 displays content etc. received from an external content server or a broadcast station. The display device 30 is provided with, on its front face side, a touch panel 6. By touching the touch panel 6, the user can make operations on the screen.

The display device 30 is also provided with an antenna so that it can receive content wirelessly.

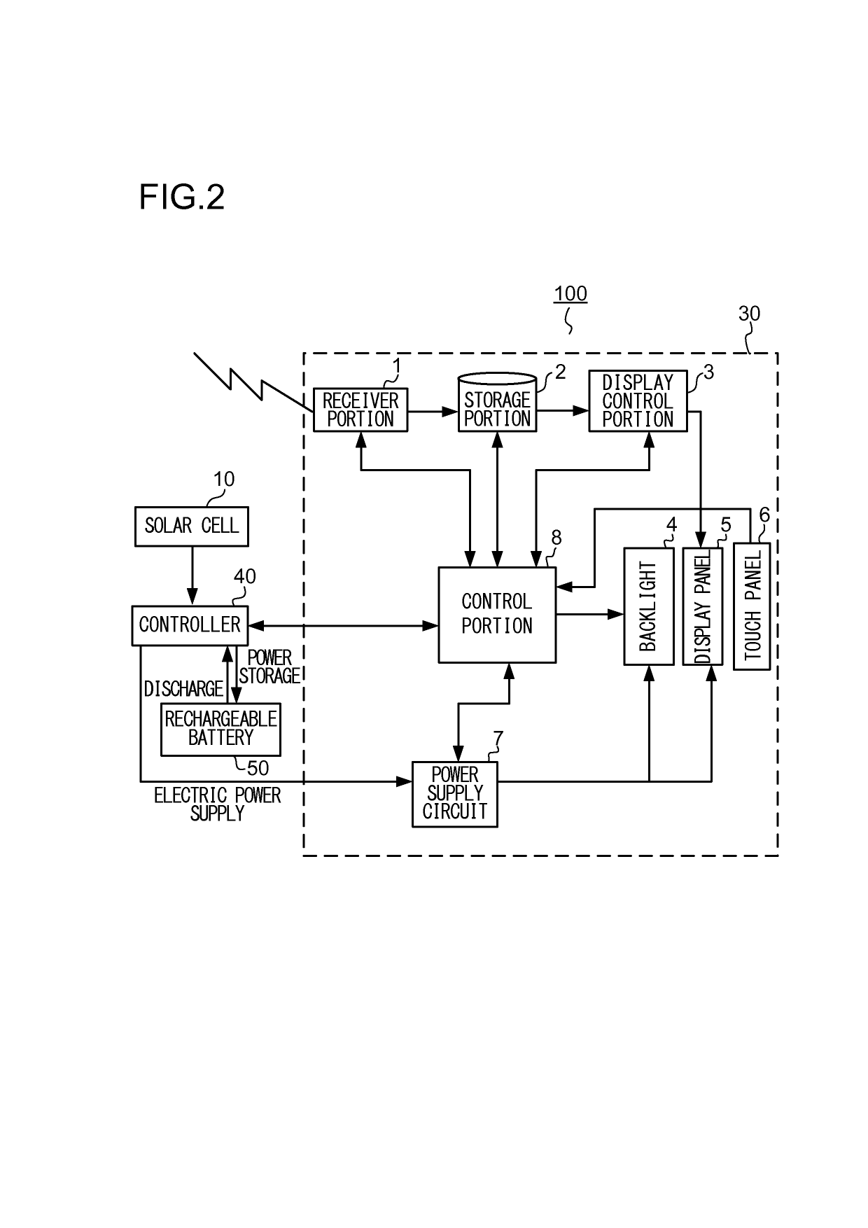

A block diagram of the outdoor display system 100 is shown in FIG. 2. As already described partly with reference to FIG. 1, the outdoor display system 100 is provided with a solar cell 10, a display device 30, a controller 40, and a rechargeable battery 50. The display device 30 includes a receiver portion 1, a storage portion 2, a display control portion 3, a backlight 4, a display panel 5, a touch panel 6, a power supply circuit 7, and a control portion 8.

The controller 40 supplies the electric power generated by the solar cell 10 to the display device 30 and the rechargeable battery 50. In principle, the controller 40 supplies the greater part of the electric power generated by the solar cell 10 intact to the display device 30. The controller 40 supplies the surplus electric power (the electric power corresponding to the difference between the electric power generated by the solar cell 10 and the electric power consumed by the display device 30) to the rechargeable battery 50. During the night and in rainy weather, the controller 40 so controls that electric power is supplied from the rechargeable battery 50 to the display device 30. That is, the electric power stored in the rechargeable battery 50 is supplied via the controller 40 to the display device 30.

The control portion 8 includes, for example, a CPU, and controls different parts of the display device 30 while collecting status information on them. The control portion 8 also controls those different parts according to the collected status information. Moreover, information on distribution of electric power supply between the display device 30 and the rechargeable battery 50 is transmitted from the controller 40 to the control portion 8.

The display panel 5 is the part that displays images, and is, in the display device 30, implemented with a liquid crystal display (LCD) panel. In the liquid crystal display panel, according to the image to be displayed, the part of liquid crystal corresponding to each pixel is driven into an ON state, an Off state, or an intermediate state between them.

The backlight 4 illuminates the display panel 5 with white light. The backlight 4 includes, for example, a cold cathode fluorescent tube (CCFL) or an LED light source. From the standpoint of reducing power consumption, it is preferable to use an LED light source.

The touch panel 6 is a capacitive sensor in the form of a transparent sheet which is arranged on protective glass (not shown) on the front face side of the display panel 5. The touch panel 6 accepts operations made by the user.

The receiver portion 1 includes an antenna for receiving a signal transmitted by wireless communication (for example, by methods such as WiMAX and IEEE802.11b/g) from an external content server (for example, an ASP server or a personal computer) or a broadcast station, and a signal processing portion that demodulates the signal received via the antenna. For example, in a case where the wireless signal is one in the MPEG2-TS format delivered in a form modulated by the OFDM method, the receiver portion 1 performs OFDM demodulation to extract an MPEG2-TS signal. The extracted MPEG2-TS signal is fed to the storage portion 2.

The storage portion 2 stores the MPEG2-TS signal extracted by the receiver portion 1. Specifically, the storage portion 2 stores content transmitted from the content server or the broadcast station. When the content is real-time content (when the received content is to be displayed instantaneously on the display panel 5), the storage portion 2 functions as a buffer memory. When the content is content that is to be displayed in response to an operation by the user, or content that is to be displayed according to a previously set time schedule, the storage portion 2 functions as a storage medium.

The display control portion 3 controls the display on the display panel 5. Specifically, according to the content to be displayed, the display control portion 3 modulates the part of liquid crystal corresponding to each pixel of the display panel 5. The display control portion 3 requires fast processing, and is therefore implemented with dedicated hardware circuitry provided separately from the control portion 8.

The power supply circuit 7 supplies different parts of the display device 30 with electric power. In view of the fact that the display panel 5 and the backlight 4 consume more electric power than the rest of the display device 30, in FIG. 2, the power supply circuit 7 is shown as if supplying only the display panel 5 and the backlight 4 with electric power; in reality, however, the power supply circuit 7 also supplies the receiver portion 1, the storage portion 2, the display control portion 3, the touch panel 6, etc. with electric power.

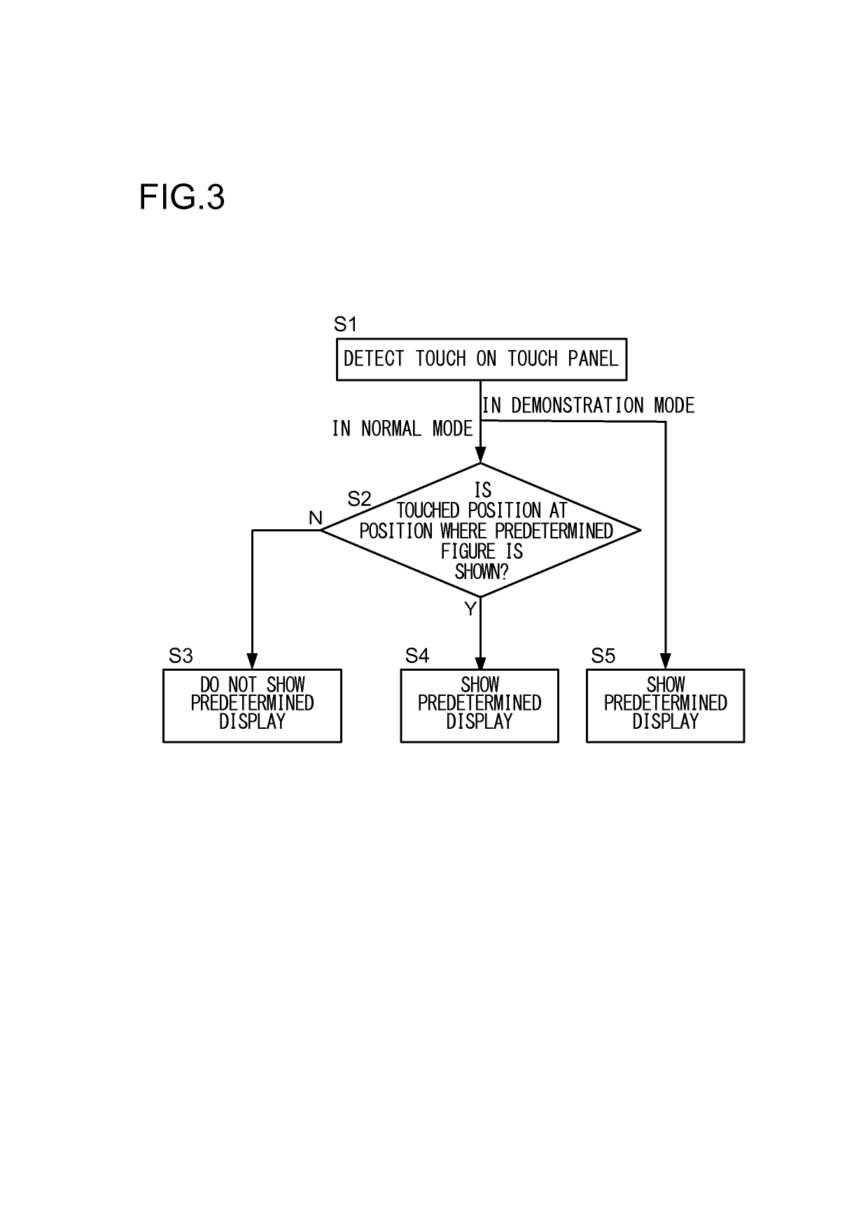

Next, the control performed when the screen of the outdoor display system 100 is operated will be described with reference to the flow chart in FIG. 3.

First, suppose that an image is being displayed on the display panel 5. When the user touches the touch panel 6, the control portion 8 detects the touch (Step S1). If the operation mode is a normal mode, the control portion 8 checks whether or not the position of the touch on the touch panel 6 is the display position of a predetermined figure such as a button or an icon (Step S2). If the touch position is the display position of the predetermined figure (Step S2, “Y” (“yes”)), the control portion 8 instructs the display control portion 3 to show a predetermined display (Step S4). If the touch position is not the display position of the predetermined figure (Step S2, “N” (“no”), the control portion 8 does not show the predetermined display (Step S3).

After Step S1, if the operation mode is a demonstration mode, irrespective of the touch position on the touch panel 6, the control portion 8 instructs the display control portion 3 to show the predetermined display, so that the predetermined display is shown (Step S5). That is, in the demonstration mode, no matter where the user touches the screen, the predetermined display is shown.

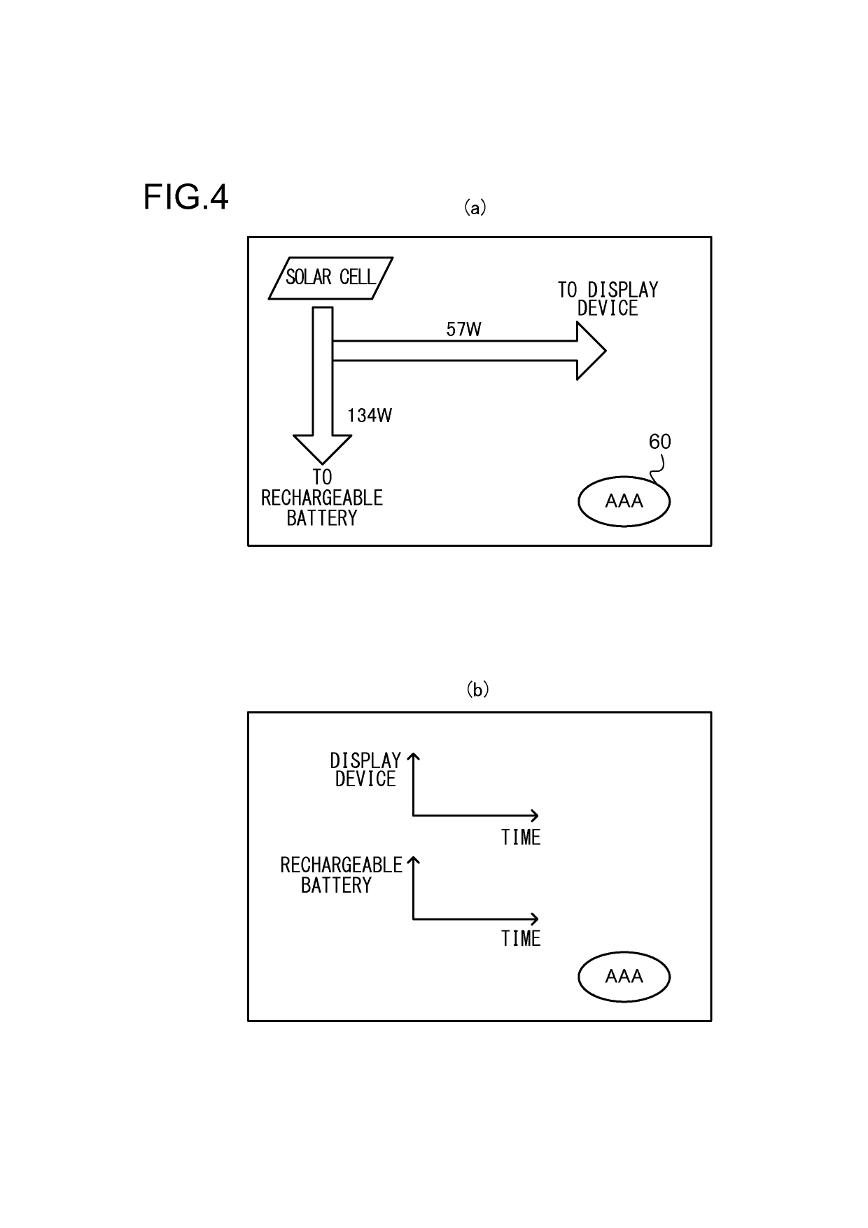

For example, suppose, in an initial state, an image as shown in FIG. 4(a), namely an image indicating the distribution of the supply of the electric power generated by the solar cell 10 between the rechargeable battery 50 and the display device 30, is being displayed. In a lower right-hand part of the image shown in FIG. 4(a), an icon 60 is shown.

If the operation mode is the normal mode, when the user touches the touch panel 6 at the position where the icon 60 is shown, an image as shown in FIG. 4(b), namely an image indicating chronological records of the supply of electric power to the display device 30 and the rechargeable battery 50, is displayed on the display panel 5. On the other hand, when the user touches the touch panel 6 elsewhere than at the position where the icon 60 is shown, no switching is performed to the image shown in FIG. 4(b), but the image shown in FIG. 4(a) continues to be displayed. That is, in the flow chart of FIG. 3, “SHOW PREDETERMINED DISPLAY” denotes, for example, performing switching from a state where one image (FIG. 4(a)) is being displayed to a state where another predetermined image (FIG. 4(b)) is being displayed. On the other hand, “DO NOT SHOW PREDETERMINED DISPLAY” denotes performing no switching to a state where another predetermined image is being displayed (that is, maintaining a state in which one image is being displayed).

“SHOW PREDETERMINED DISPLAY” also denotes, for example in a case where the content is a Power Point (registered trademark) slide show, turning from one page to the next. “DO NOT SHOW PREDETERMINED DISPLAY” then denotes continuing to display the current page without turning to the next.

By contrast, if the operation mode is the demonstration mode, in a state where the image shown in FIG. 4(a) is being displayed, no matter where the user touches the touch panel 6, switching is performed to the display of the image shown in FIG. 4(b). That is, even when the user touches the touch panel 6 elsewhere than at the position where the icon 60 is shown, the displayed image is switched.

As described above, with the outdoor display system 100, when the operation mode is the demonstration mode, no matter where the user touches the display screen, a predetermined display is shown. This improves ease of operation in the demonstration mode.

### Embodiment 2

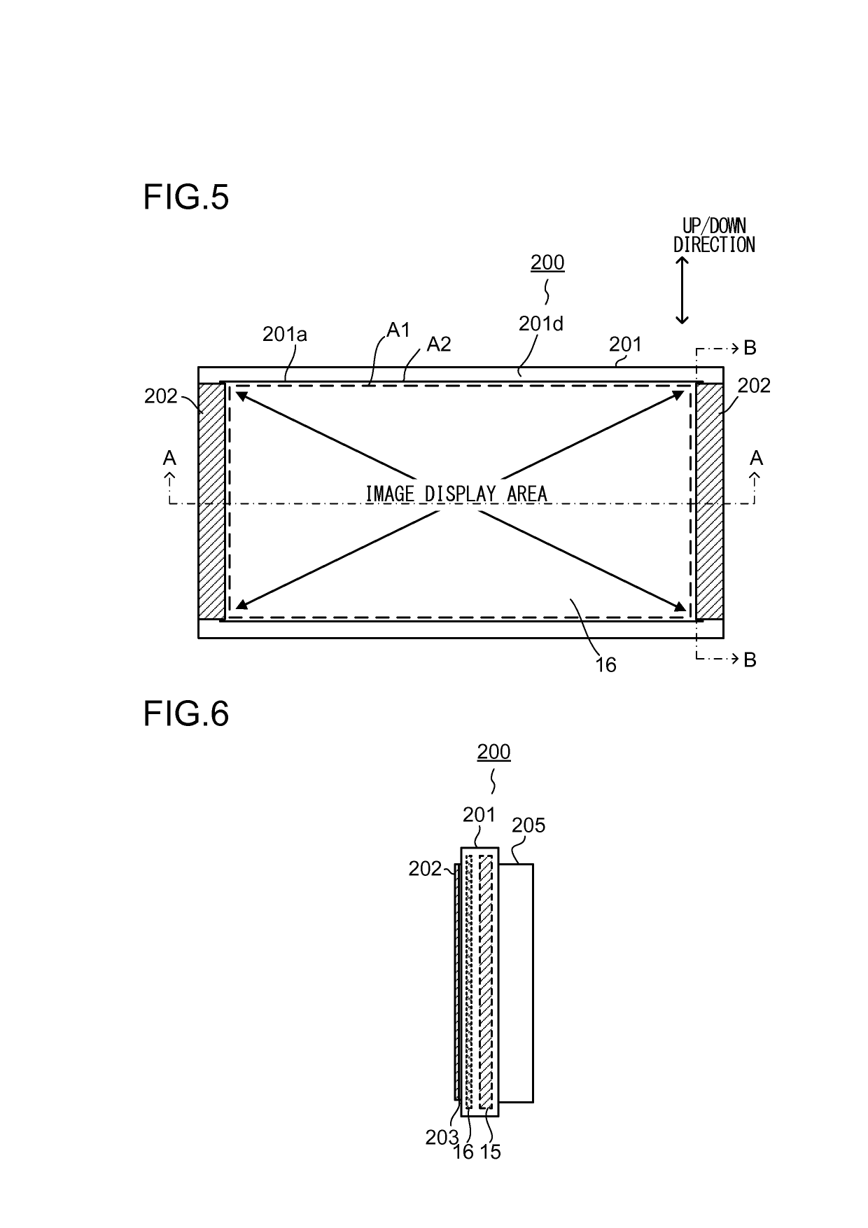

A front view, a side view, and a bottom view of a display device 200 according to a second embodiment of the invention are shown in FIGS. 5, 6, and 7 respectively.

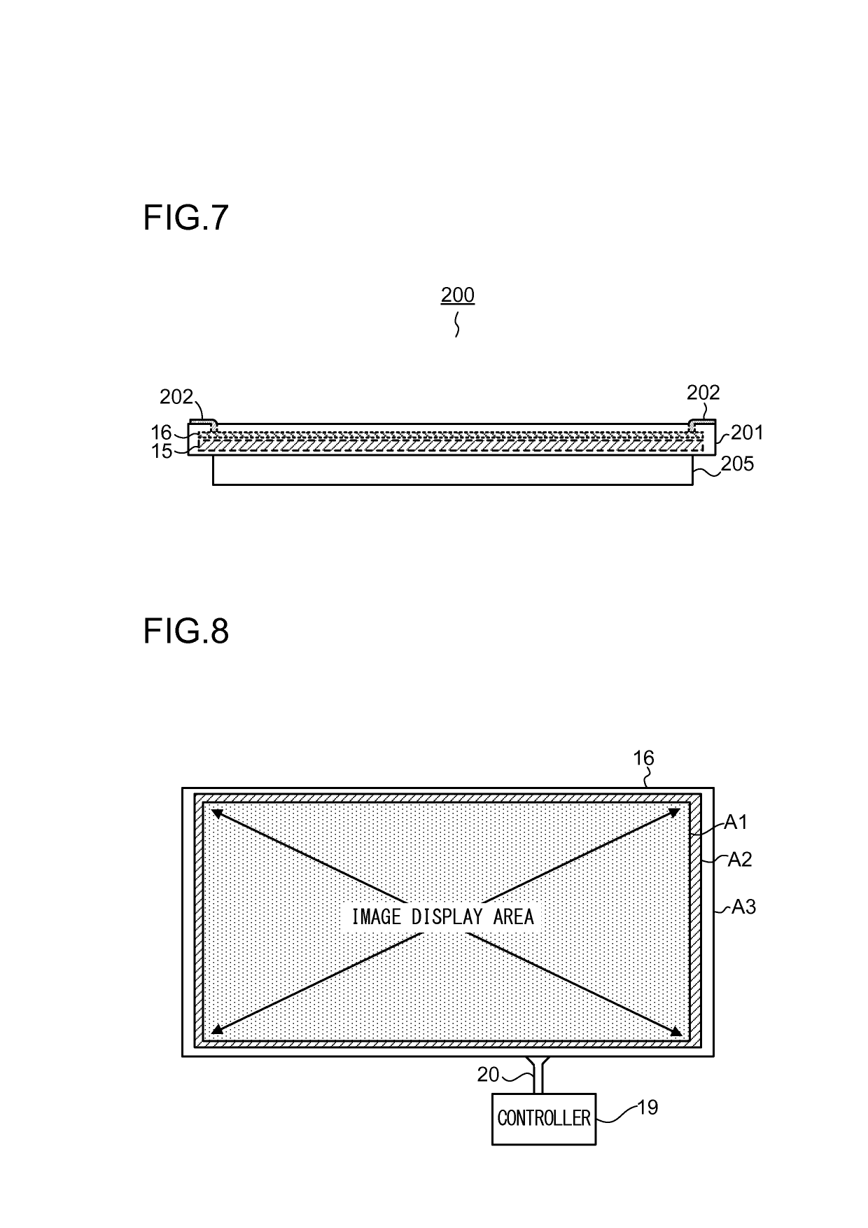

As shown in FIG. 6 or 7, the display device 200 includes a cabinet, which is composed of a front cabinet 201 and a rear cabinet 202, a display panel 15, and a touch panel 16. On the front face side of the display panel 15, the touch panel 16 is arranged. As shown in FIGS. 5 and 7, in the display device 200, the display panel 15 and the touch panel 16 are approximately the same size. The front and rear cabinets 201 and 205 are formed of metal such as aluminum or iron, and are fastened together with screws into a single unit. The front cabinet 201 is configured so that the display panel 15 and the touch panel 16 can be fixed to it, and the front cabinet 201 functions as a frame member that supports the display panel 15 and the touch panel 16. Once the front and rear cabinets 201 and 205 are fastened together, the display panel 15, the touch panel 16, a drive circuit board for the display panel 15, etc. are accommodated inside. The front and rear cabinets 201 and 205 may be formed of resin from the standpoint of reducing weight; considering, however, that they are used in a display device for use outdoors, from the standpoint of durability etc., it is preferable that they be formed of metal. Today, some cabinets are available which have their surface painted so as to be usable outdoors, and therefore it is possible to use cabinets formed of resin. The display panel 15 is the part that actually displays an image, and is, in the display device 200, implemented with a liquid crystal display panel.

FIG. 8 is a front view of the touch panel 16 provided in the display device 200. The touch panel 16 is a light-transmitting sensor which detects a touch by the user, and is, in the display device 200, implemented with a capacitive touch panel. The touch panel 16 has an electrode layer composed of sensor wires arranged on the back face of a glass sheet. The touch panel 16 has a controller 19 connected to it via a flexible cable 20. When a fingertip of the user touches the glass sheet, a change in capacitance occurs, which causes the frequency of a pulse signal fed to the sensor wires to change. Based on the change in frequency, the controller 19 detects the coordinates of the position of the touch with the fingertip. The electrode layer may instead be composed of transparent electrodes.

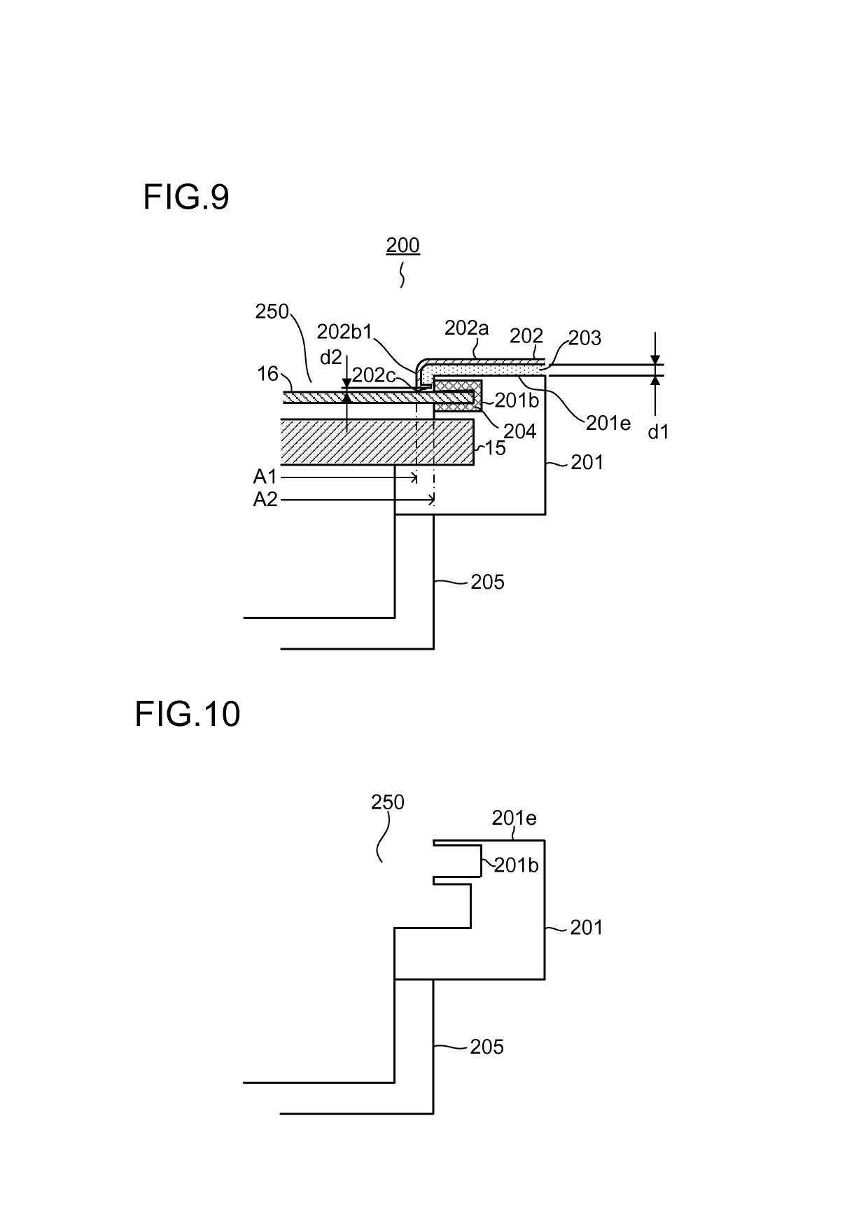

FIG. 9 shows part of the sectional view along line A-A in FIG. 5 (while FIG. 10 is a diagram showing only the front and rear cabinets 201 and 205 out of what is shown in FIG. 9). FIG. 9 shows a left-hand part of the display device 200 as seen from behind, that is, a right-hand part of the display device 200 as seen from in front. The front cabinet 201 of the display device 200 is shaped symmetrically left to right, so that (with the display device 200 seen from in front) the front cabinet 201 has a similar shape as in FIG. 9. The display panel 15 is fixed in a front part of the front cabinet 201. The display panel 15 and the touch panel 16 are arranged in a front-side opening 250 in the front cabinet 201. Outside the front-side opening 250, a recess 201b is formed. In the recess 201b, a gasket 204 is inserted so as to fit the wall surfaces of the recess 201b. When the touch panel 16 is fitted in the recess 201b lined with the gasket 204, edge parts (left and right edges) of the touch panel 16 are held in the gasket 204. The touch panel 16 is thereby fixed on the front face side of the display panel 15. The gasket 204 is formed of rubber, so that it, on one hand, electrically insulates the front cabinet 201 and the touch panel 16 from each other and, on the other hand, functions to absorb impact on the touch panel 16. In a case where the front cabinet 201 is formed of resin, the gasket 204 is optional.

Back in FIG. 8 (or FIG. 5), the touch panel 16 has an image display area A1 where the display panel 15 displays an image, a detection-enabled area A2 where a touch by the user can be detected, and a contour area A3. The area A2 is larger than the area A1 (that is, the greater part of the area A2 overlaps the area A1). The area A3 is larger than the area A2. The region outside the image display area A1 and not overlapped by the detection-enabled area A2 (that is, the region inside the contour area A3 but outside the detection-enabled area A2) is, at its left and right edge parts, held in the gasket 204 inserted in the recess 201b in the front cabinet 201. The front-side opening 250 in the front cabinet 201 has approximately the same size as the detection-enabled area A2, and, as shown in FIG. 5, with the touch panel 16 fixed, the detection-enabled area A2 of the touch panel 16 is exposed through the front-side opening 250. Thus, the user can make touch operations not only in the image display area A1 but also in the detection-enabled area A2.

As shown in FIG. 9, from a side portion 201e of the front face 201d (FIG. 5) of the front cabinet 201 to the front-side opening 250, an insulating member 203 is provided. The insulating member 203 is, for example, rubber sponge, and the part of the insulating member 203 located over the front face 201d of the front cabinet 201 has a thickness d1 of about 3 mm. On the surface of the insulating member 203, an electrically conductive extended detection area portion 202 is provided. The insulating member 203 electrically insulates the extended detection area portion 202 from the front cabinet 201. In a case where the front cabinet 201 is formed of resin, the insulating member 203 is optional.

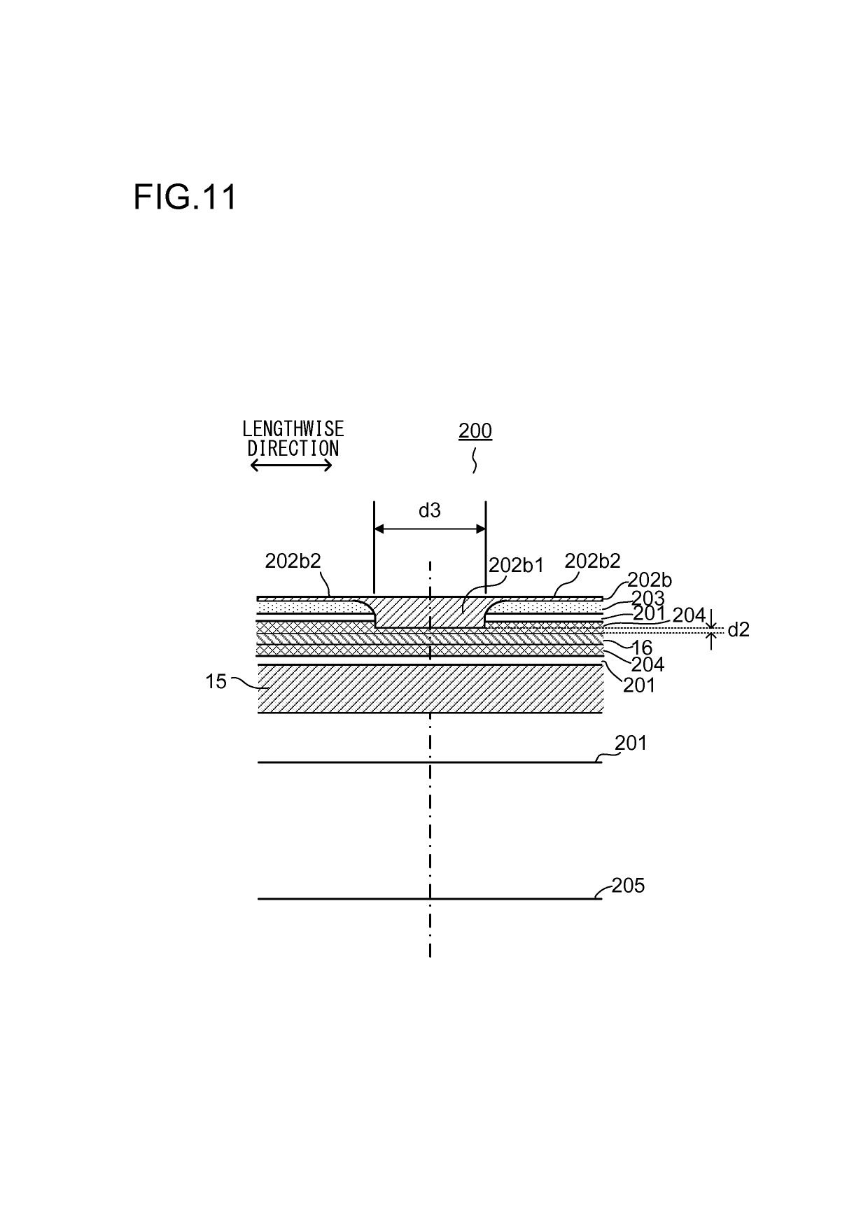

Next, with reference to FIGS. 9 and 11, the extended detection area portion 202 will be described. FIG. 11 shows part of the sectional view along line B-B in FIG. 5, and shows a central part of the display device 200 in the up/down direction. The extended detection area portion 202 is formed of, for example, copper foil tape, and has an extending portion 202a, which extends so as to cover the front face of the insulating member 203, and a protruding portion 202b, which protrudes from the inner edge of the extending portion 202a in a direction approaching the surface of the touch panel 16 (in the backward direction). The protruding portion 202b, in a region 202b1 located in a central part in the lengthwise direction and having a predetermined width d3, protrudes to a position close to, at a distance of d2 from, the surface of the touch panel 16 and, in a region 202b2 elsewhere, protrudes less. Preferably, the dimension d2 is about 1 mm, and the predetermined width d3 is one to three fingers wide (about 2 cm). The dimension d2 may be zero so that the protruding portion 202b makes contact with the touch panel 16, but from the standpoint of preventing scratches on the touch panel 16, it is preferable that the dimension d2 not be zero. The extending portion 202a, which the user may touch, may be painted, or covered with a thin insulating material.

As shown in FIG. 9 in particular, from a back face portion of the region 202b1, a protruding portion 202c protrudes approximately perpendicularly outward. The back face portion of the region 202b1 and the protruding portion 202c are located opposite the region outside the image display area A1 and overlapped by the detection-enabled area A2 (the hatched part in FIG. 8 corresponds to it), at a distance of d2 from it (see FIG. 9). When this extended detection area portion 202 is touched by the user, the controller 19 regards the surface of the touch panel 16 as being touched at a position opposite the back face portion of the region 202b1 and the protruding portion 202c, and detects that position as the touch position. Thus, no direct touch on the surface of the touch panel 16 is needed, but a touch on the extended detection area portion 202 suffices for the touch panel 16 to be detected being indirectly touched. This makes the surface (in particular, the image display area A1) of the touch panel 16 less prone to be soiled, and helps alleviate deterioration of viewability of the image.

Moreover, when the detected touch position expands over a large region on the touch panel 16, the controller 19 recognizes it not as an actual touch by the user but as an effect of noise such as ambient radio waves. Accordingly, if the protruding portion 202b is provided over the entire region of the touch panel 16, when the user touches the extended detection area portion 202, the touch may be erroneously recognized not as a touch on the extended detection area portion 202 but as an effect of noise. To prevent that, in this embodiment, of the protruding portion 202b, only the region 202b1 in a central part in the lengthwise direction is located close to the touch panel 16. This helps suppress erroneous recognition.

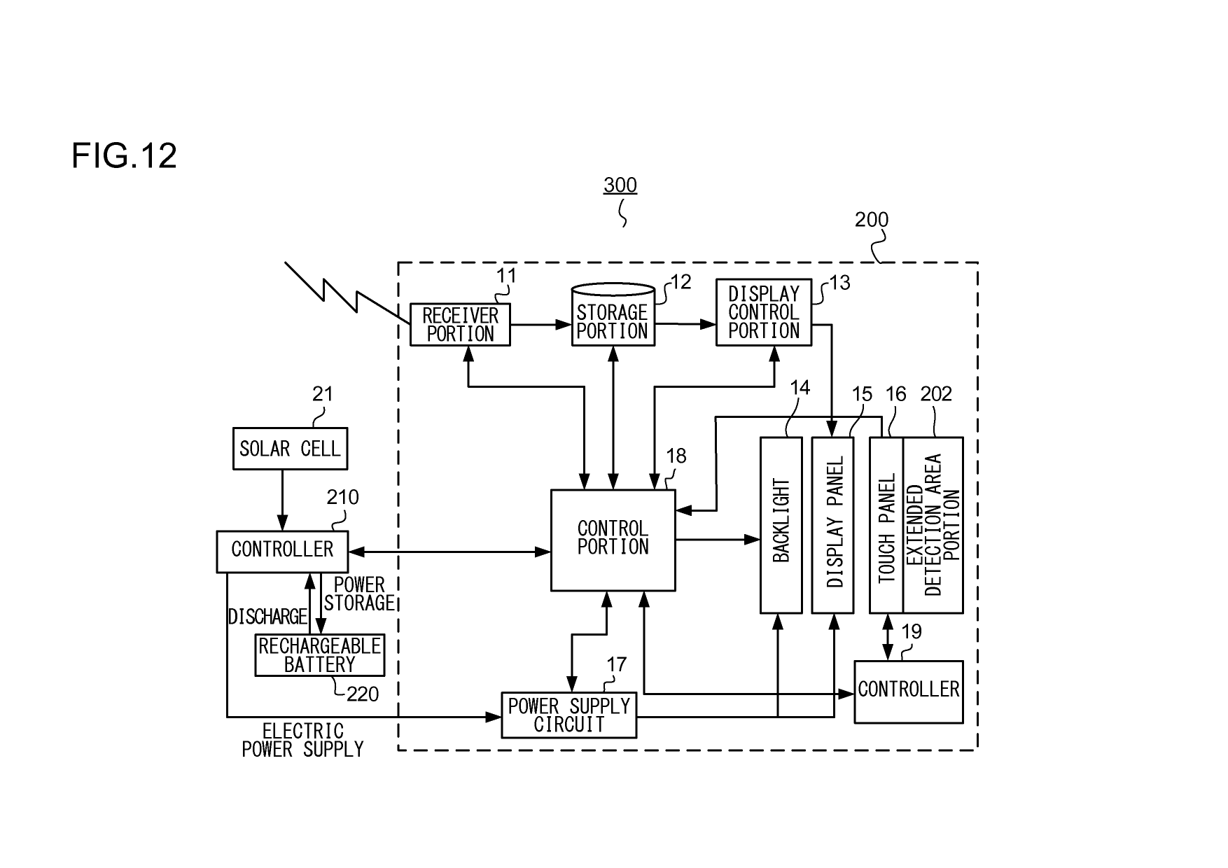

A block configuration diagram of a display system 300 including the display device 200 described above is shown in FIG. 12. Like the display system 100 according to the first embodiment, this display system 300 is for use outdoors.

As shown in FIG. 12, the display system 300 includes a solar cell 21, a controller 210, a rechargeable battery 220, and a display device 200. The display device 200 includes a receiver portion 11, a storage portion 12, a display control portion 13, a backlight 14, a display panel 15, a touch panel 16, an extended detection area portion 202, a power supply circuit 17, a control portion 18, and a controller 19. The functions of the receiver portion 11, the storage portion 12, the display control portion 13, the backlight 14, the display panel 15, the power supply circuit 17, and the control portion 18 are similar to the functions of the receiver portion 1, the storage portion 2, the display control portion 3, the backlight 4, the display panel 5, the power supply circuit 7, and the control portion 8, respectively, in the first embodiment, and therefore no detailed description of these blocks will be repeated.

Like the touch panel 6 in the first embodiment, the touch panel 16 is a capacitive sensor in the shape of a transparent sheet which is arranged on protective glass (not shown) on the front face side of the display panel 15. Moreover, as shown in FIG. 8, the touch panel 16 has the controller 19 connected to it, and the control portion 18 controls the controller 19. The control portion 18 and the controller 19 communicate with each other via an interface such as USB or RS-232C.

As described previously, the extended detection area portion 202 is the region outside the image display area A1 of the touch panel 16. The extended detection area portion 202 extends the area in which a touch by the user can be detected.

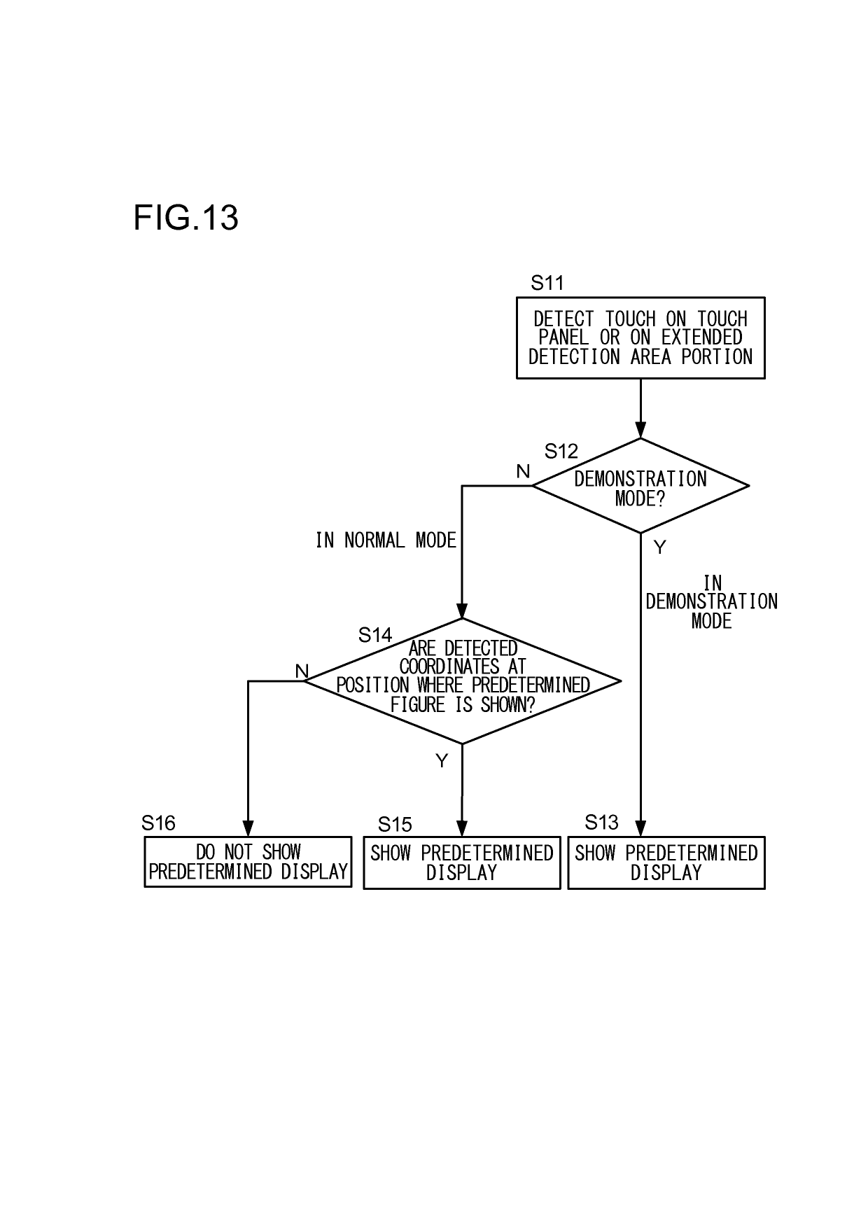

Next, the control performed when the screen of the outdoor display system 300 is operated will be described with reference to the flow chart shown in FIG. 13.

The control in the outdoor display system 300 is basically the same as that in the outdoor display system 100 (see FIG. 3). A difference is that, whereas in the outdoor display system 100, only touches by the user on the touch panel 6 itself are regarded as touch operations (S1 in FIG. 3), in this embodiment, touches by the user not only on the touch panel 16 itself but also on the extended detection area portion 202 are regarded as touch operations (Step S11).

The following steps, namely Steps S13, S14, S15, and S16 are similar to Steps S5, S2, S4, and S3, respectively, in FIG. 3.

The setting of the demonstration mode and the normal mode may be done by the administrator of the display device 200 through operation of the touch panel 16. For example, the modes can be switched by holding the touch panel 16 pressed for a while. Or the display device 200 may be provided with a dedicated operation portion such as a keyboard so that the modes can be set through operation of it. Or different pages of displayed content may be set for either the demonstration or normal mode; for example, it is possible to set the first several pages for the demonstration mode as pages for demonstration to customers and the latter several pages for the normal mode as pages that can actually be operated by customers.

Conventionally, digital signage devices incorporating touch panels are touched by a large number of people, and thus, inconveniently, the touch panels are prone to be soiled with fingerprints and the like. This leads to deterioration of viewability of the image, and makes it necessary to clean the touch panels frequently by wiping them with cloth or the like.

By contrast, with the display device 200 described above, the touch panel 16 can be operated with touches not only on the touch panel 16 itself but also on the extended detection area portion 202 which is the region outside the touch panel 16 itself. This improves ease of operation in the demonstration mode in particular, leading to increased convenience. Moreover, the touch panel 16 can be operated without direct touches on it, and this makes the touch panel 16 less prone to be soiled.

### Embodiment 3

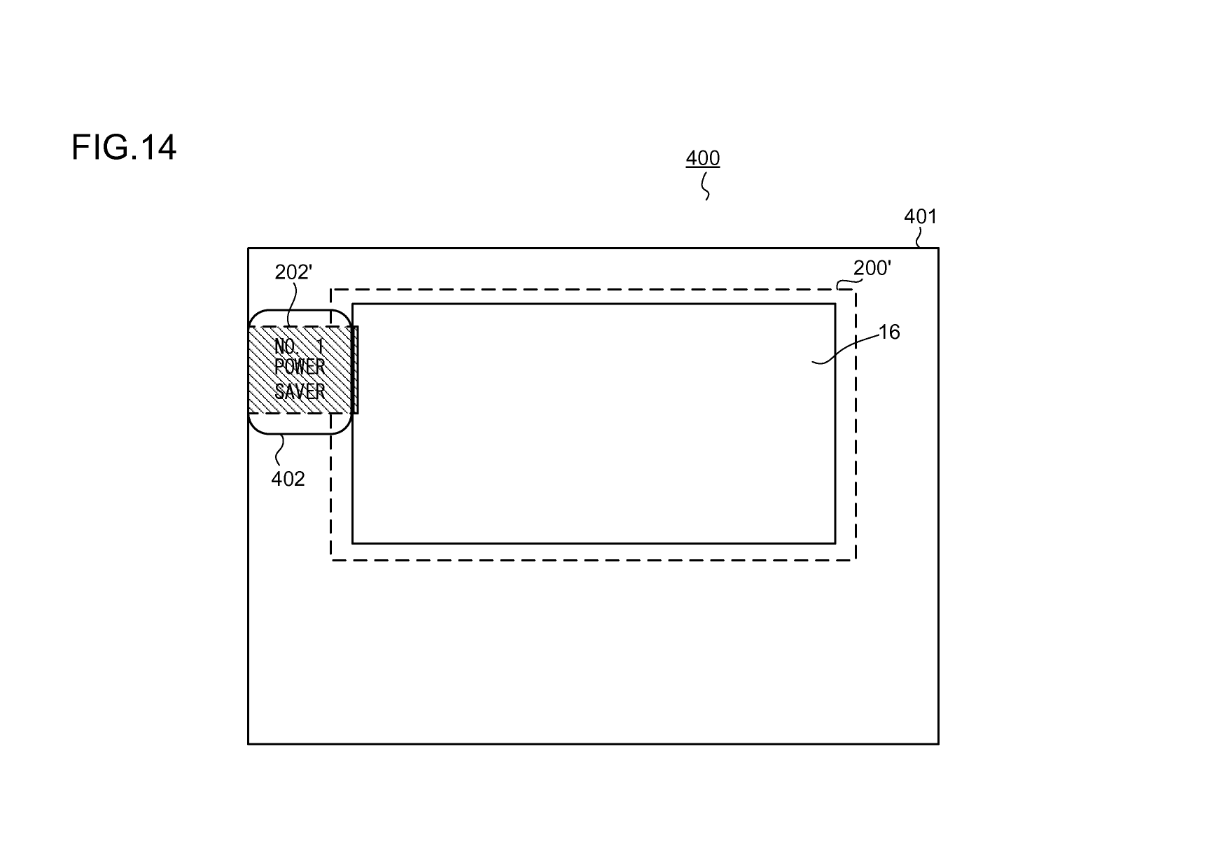

A third embodiment of the invention will now be described. This embodiment deals with a kiosk terminal 400 installed on the street or in a store or the like. A front view of the kiosk terminal 400 is shown in FIG. 14. In the kiosk terminal 400, for example, a display device 200′ is provided inside a kiosk cabinet 401. The display device 200′ has a similar structure to the display device 200 described previously, but differs from it in the configuration of the extended detection area portion (202). Specifically, as shown in FIG. 14, the extended detection area portion 202′ here is fitted on the front face of the kiosk cabinet 401. Covering the extended detection area portion 202′ with paint, a sticker, or the like carrying an advertising message 402 helps obtain a not very unconventional design.

### Embodiment 4

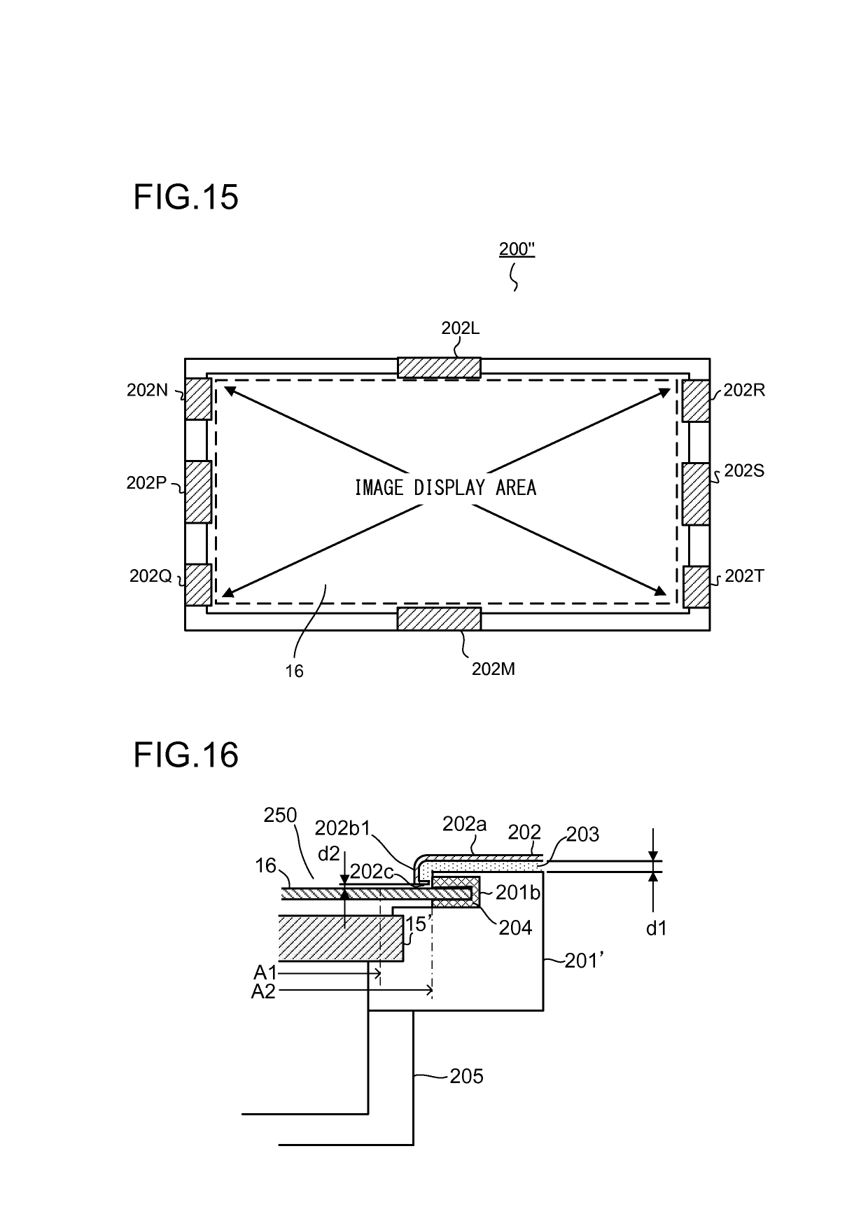

A display device 200″ according to a fourth embodiment of the invention will now be described with reference to FIG. 15. In the display device 200″, extended detection area portions 202L, 202M, 202N, 202P, 202Q, 202R, 202S, and 202T are provided at the top, bottom, upper left, left, lower left, upper right, right, and lower right, respectively, of the touch panel 16. For example, while map content is being displayed on the display panel of the display device 200″, when the extended detection area portion 202L is touched, a map of a location to the north of the currently displayed location is shown. In this way, the extended detection area portions can be used as direction keys.

### Embodiment 5

In the embodiments described previously, the display panel 15 and the touch panel 16 are assumed to be the same size; instead, the display panel may be given a smaller size than the touch panel 16. A corresponding embodiment will now be described with reference to FIG. 16. In this embodiment, the display panel 15′ has a smaller size than the touch panel 16, and the outer edges of the display panel 15′ are located inward of the protruding portion 202b of the extended detection area portion 202. Also in this structure, the back face portion of the region 202b1 and the protruding portion 202c are located opposite the detection-enabled area A2, and thus when the extended detection area portion 202 is touched by the user, the touch panel 16 is detected being touched.

### Embodiment 6

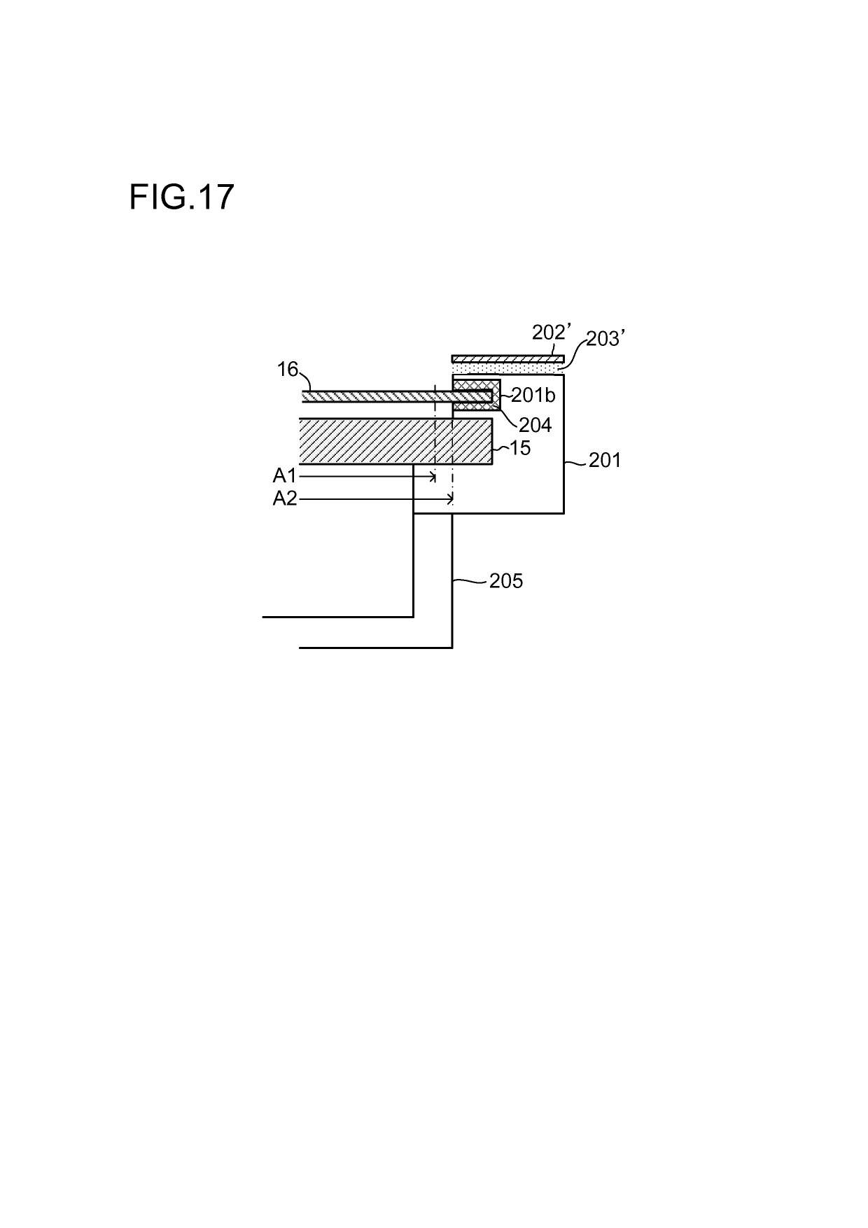

As shown in FIG. 17, there may be provided no portion (like the protruding portion 202c) that is located opposite the touch panel 16. Although this results in lower sensitivity compared with a structure having the protruding portion 202c etc., so long as the touch panel 16 can detect a change in capacitance when the extended detection area portion 202′ is touched by a human finger, such a structure is also possible.

The embodiments by way of which the present invention has been described above allow for many modifications and variations within the spirit of the invention.

For example, although the second embodiment deals with a case where the extended detection area portion 202 is provided only in left and right parts of the display device 200, it may instead be provided only in top and bottom parts of the display device.

Although the embodiments described above deal with examples where the display portion of the display device is implemented with a liquid crystal display panel, it may instead be implemented with a plasma panel, an organic EL panel, electronic paper, a CRT, an advertising film, or the like. The power source for the display device is not limited to electric power generated by a solar cell, but may be commercially distributed electric power.

### LIST OF REFERENCE SIGNS

10 solar cell
20 mounting base
30 display device
40 controller
50 rechargeable battery
60 icon
100 outdoor display system
15 display panel
16 touch panel
200 display device
201 front cabinet
202 extended detection area portion
203 insulating member
204 gasket
205 rear cabinet
300 display system
400 kiosk terminal
401 kiosk cabinet
402 advertising message
A1 image display area
A2 detection-enabled area
A3 contour area

1: A display system comprising:
a display portion;
a display control portion;
a touch panel; and
a detection portion for detecting a touch on the touch panel, wherein
in a first operation mode, the display control portion shows a predetermined display when the touch on the touch panel occurs at a position of a predetermined figure, and
in a second operation mode, the display control portion shows the predetermined display whenever the touch occurs, irrespective of presence or absence of the predetermined figure and irrespective of position of the touch.

2: The display system according to claim 1, wherein
the first mode is a normal mode, and the second mode is a demonstration mode.

3: The display system according to claim 1, further comprising:
a solar cell;
a power storage device for storing electric power obtained by the solar cell; and
a display device comprising the display portion, the display control portion, the touch panel, and the detection portion, wherein
the display device is fed with electric power from the solar cell and the power storage device.

4: A display device comprising:
a display portion;
a display control portion;
a light-transmitting touch panel provided on a front face side of the display portion; and
an electrically conductive member provided outside an image display area where the display portion displays an image, wherein
the display control portion controls the display portion to show a predetermined display when a touch occurs on the touch panel or on the electrically conductive member.

5: A display device comprising:
a display portion;
a display control portion;
a light-transmitting touch panel provided on a front face side of the display portion; and
an electrically conductive member provided such that part thereof is located opposite a region of the touch panel outside the image display area of the display portion and overlapped by a detection-enabled area of the touch panel, wherein
the display control portion controls the display portion to show a predetermined display when a touch occurs on the touch panel or on the electrically conductive member.

6: The display device according to claim 5, wherein
the electrically conductive member has
an extending portion extending along a front face of the display device and
a protruding portion protruding from part of the extending portion in a lengthwise direction thereof to close to the region of the touch panel.

7: The display device according to claim 4, wherein
in a first operation mode, the display control portion controls the display portion to show a predetermined display when a touch occurs on the touch panel, and
in a second operation mode, the display control portion controls the display portion to show the predetermined display when a touch occurs on the touch panel or on the electrically conductive member.

8: The display device according to claim 7, wherein
the first mode is a normal mode, and the second mode is a demonstration mode.
